(19) United States
(12) Patent Application Publication
(10) Pub. No.: US 2016/0014976 A1
(43) Pub. Date: Jan. 21, 2016

(54) WATER-ACTUATED GROWING CONTAINER AND UNIT

(71) Applicant: Imad A. Kallabat, West Bloomfield, MI (US)

(72) Inventor: Imad A. Kallabat, West Bloomfield, MI (US)

(21) Appl. No.: 14/336,160

(22) Filed: Jul. 21, 2014

(51) Int. Cl. A01G 9/02

(52) U.S. Cl. CPC A01G 9/02

(57) ABSTRACT

A water-actuated container used for transporting soil containing a plant or seed to a location to be planted wherein the soil does not need to be removed from the container before being placed into the ground due to the fact that the container is fully biodegradable and, upon being watered, the container dissolves and releases plant nutrients to the surrounding soil in order to provide further sustenance to the plant during its growth cycle.

### CROSS-REFERENCE TO RELATED APPLICATION

This application is a completion application of and claims the benefit of U.S. Provisional Patent Application No. 61/856,261, filed on Jul. 19, 2013, entitled “Water-Actuated Growing Container and Unit,” the disclosure of which is hereby incorporated by reference, in its entirety, including the drawings.

### BACKGROUND OF THE INVENTION

1. Field of the Invention

The present invention pertains to a growing container and unit, and more particularly, to a water-actuated growing container and unit for seeds and plants that is biodegradable and which comprises compressed plant nutrients.

2. Description of the Prior Art

Seeds and young plants are often placed in individual or group planting trays, or growing containers, which containers may be filled with a potting soil mixture comprising of soil and/or plant nutrients. Such containers are generally used to transport plants from a greenhouse or other initial location to the site at which they will be planted. Maintaining the plant in a potting soil mixture in such a growing container or in proximity to plant nutrients substantially helps the plant to continue growing after it is removed therefrom, as the plant is continuously surrounded by growth sources before and after it is planted in the ground.

Growing containers often comprise synthetic materials and, generally, are made of plastic. Plastics such as polyethylene and polystyrene have been favored for use in growing containers due in part to their weathered and dimensional resilience, which protects the container from harsh conditions during storage and transport. However, such plastic growing containers may not be planted in the ground along with the plant. Thus, a user of plastic growing containers must first remove the plant and accompanying potting soil mixture from the growing container prior to situating them within the ground. This requires the user to manage the plastic growing container and to ensure that it is disposed of properly and with a minimum environmental impact.

A solution known in the art is to use biodegradable materials in place of those synthetic compositions, which biodegradable materials may safely be planted in the ground along with the plant and included potting soil mixture. Biodegradable growing containers may be composed of organic or other materials and generally break down gradually over some period of time due to exposure from air, water, or other elements until the containers vanish entirely. As such, eventually, these biodegradable growing containers will dissolve until all that remains in the ground is the seed or plant and accompanying potting soil mixture.

Nevertheless, neither synthetic nor biodegradable growing containers provide any additional benefit to the seed or plant disposed therein aside from protecting it until it is planted. The central function of the growing container is to sustain the seed or plant until it is planted in the ground by safely storing it until such a time, yet growing containers known in the art do not provide anything further to sustain the seed or plant disposed therein. Therefore, although potting soil mixtures supply nutrients and other beneficial qualities for the seed or plant disposed within a growing container, growing containers known in the art operate solely as a container and thus do not provide any further sustenance to the plant. Furthermore, potting soil mixtures themselves may not include sufficient amounts of nutrients to feed a plant during a substantial or entire portion of its growth cycle.

Thus, while existing loading solutions allow for the safe dissolution of planted growing containers, and while potting soil provides certain benefits to the growth of plants, various drawbacks, including those mentioned above, remain.

Accordingly, a need exists for a growing container and unit that overcome the disadvantages of the prior art, while maintaining the benefits of the prior art. A further need exists for a biodegradable growing container and unit that safely dissolves from exposure to water. Moreover, a need exists for a growing container and unit that comprise compressed plant nutrients to provide additional support for sustaining the plant disposed therein or in proximity thereto.

### SUMMARY OF THE INVENTION

The present invention comprises a water-actuated growing container and unit that is biodegradable and at least partially comprises compressed plant and/or soil nutrients. As used herein, “nutrients” may include, but are not necessarily limited to, fertilizer, fertilizer blends, minerals (such as calcium or magnesium, for example), and pH balancers (such as lime, for instance), and may be any substance that may nourish a plant and/or improve the growing conditions to which a plant is subject.

The water-actuated growing container comprises a container portion, which is capable of storing at least one seed or plant and a potting soil mixture therein. The container portion comprises at least one side wall that extends upward from the outside perimeter of the bottom wall leaving an opening at the top of the container and a hollow interior for potting soil to be placed into. The container portion further comprises either a single aperture or, preferably, a plurality of apertures to be located on the at least one side wall or bottom wall, equidistant from one another. The aperture allows for roots to extend outward away from the container and also for excess water to be released. Each side wall may also comprise alternating layers of nutrient-present and nutrient-absent material in order to control the amount of nutrients the plant within the container receives during the degradation period of the container.

### BRIEF DESCRIPTION OF THE DRAWINGS

FIG. 1 is a perspective view of the first embodiment of the present invention;

FIG. 2 is a perspective view of the second embodiment of the present invention;

FIG. 3 is a perspective view of the third embodiment of the present invention;

FIG. 4 is a perspective view of the fourth embodiment of the present invention; and

FIG. 5 is a perspective view of a further embodiment hereof.

### DETAILED DESCRIPTION OF THE PREFERRED EMBODIMENTS

In a first embodiment, the container portion comprises compressed plant nutrients suitable for sustaining plant growth and one or more resins and/or gels (or any other suitable binder known in the art) for bonding with the nutrients and maintaining (at least temporarily) a resilient structure. The container portion may also comprise a compressed fertilizer. However, it will be apparent that the container portion may comprise any one or more nutrients or plant nutrients that is/are capable of sustaining plant growth and/or improving the growing conditions in the vicinity of where the container is placed. The container portion may be formed into any shape, and in a preferred embodiment will feature a tapered structure. The growing unit disclosed herein has the same material composition as the container described above, and the unit is configured as a tablet or brick or other such shape such that it may be placed in proximity to a plant and release nutrients to such plant.

The water-actuated growing container further comprises at least one aperture disposed on at least one location within the container portion. The at least one aperture allows for excess water in the container portion to be drained therefrom so as to preclude the plant disposed therein from being overwatered. The at least one aperture further provides an opening through which one or more roots of the plant disposed within the container may protrude, thereby allowing the roots to extend beyond the dimensions of the container portion such that they may absorb any water dispensed onto or within the surrounding soil and grow generally as part of the usual growth process. In a preferred embodiment, a plurality of apertures are included, which apertures may be equidistantly spaced apart along a lower area and/or a bottom of the container portion.

The resins and/or gels (or any other binder ingredient or material known in the art) that bond with the compressed plant nutrients to form the container portion of the growing container or the tablet or brick portion of the unit are biodegradable and will dissolve gradually upon exposure to water. The dissolution of the resins and/or gels causes the nutrients comprising the remainder of the container portion or unit to release into and combine with the potting soil mixture. In this way, a user may water a plant disposed within the growing container as needed, which watering will cause the growing container to gradually dissolve and thus supply the plant disposed therein with additional nutrients until the entirety of the container portion has been dissolved. Alternatively, the user may dispose the unit in proximity to a plant that is being planted in soil (such as underground, in proximity to the plant's root system), which unit may thereafter gradually dissolve on being exposed to water and supply nutrients to the plant.

In an embodiment, the container and unit may be configured to include distinct layers or regions of materials, which regions may alternately comprise a region that contains the nutrients described above and a region that does not include any such nutrients (and wherein each region of the alternating region remains water-soluble). For example, the container or unit may comprise a plurality of layers, and, in an embodiment, the layer may alternate between a layer of material that includes nutrients and a layer that does not include any such nutrients. It will be apparent that when the container or unit (so configured) is watered, the container or unit will dissolve and will either release nutrients (when the layer with nutrient material is subjected to water and is thereby released into the soil and/or onto the plant) or will only dissolve (when the layer where nutrient material is absent is subjected to water). In this configuration, the container and unit may regulate the dissemination of nutrients based on the respective thicknesses (for example) of the particular nutrient-present and nutrient-absent layer or the respective configurations of the nutrient-present and nutrient-absent layers. The arrangement of such differing layers provides for additional control of the release of nutrients to the plant that is received in the container and/or growing area in which the container or unit is disposed.

In another embodiment, the water-actuated growing container may be used as a standalone container (i.e., packaging) for transporting and planting a seed or plant, which container need not be removed prior to being planted.

In a further embodiment, the growing container may be structurally configured to correspond to the shape of another tray or container within which the growing container may be transported or stored, i.e., stacked. Accordingly, the size and shape of the growing container discussed herein may be customized to match the particular dimensions of another such container or tray, such as a carrying tray for transporting a plurality of water-actuated growing containers. Furthermore, size and shape of the container may be configured to accommodate the size of the root system or other characteristics of a particular plant to be contained therein. As to the unit, it will be apparent that the unit is not limited to a particular shape or size.

In a yet further embodiment, the container disclosed herein may be configured such that it retains at least a portion of its shape and/or ability to release nutrients for at least a particular period of time, such as the time that corresponds to the growing or life cycle of a particular plant that is disposed within the container. As to the unit, it may be configured and dimensioned accordingly to allow for release of nutrients over a longer or shorter period that corresponds to the growing or life cycle of a particular plant.

In use, the water-actuated growing container disclosed herein may be planted in the ground along with the seed or plant and potting soil mixture disposed therein, or the unit may be disposed in proximity to the plant (for instance, underground and in proximity to the root system of the plant). The resins and/or gels (or any other binder ingredient or material known in the art) that bond with the compressed plant nutrients to form the container portion or unit dissolve upon exposure to water (such as when a user waters the plant and ground that is in proximity to the container). Thus, the growing container and unit gradually provide additional growth nutrients to the plant as the container or unit dissolves, such that a user may cause the growing container or unit to deliver such beneficial growth and sustenance nutrients to the plant disposed therein or thereby simply by watering the plant. Further, because the growing container and unit will eventually completely dissolve, the user need not be concerned about subsequent disposal of the container or unit.

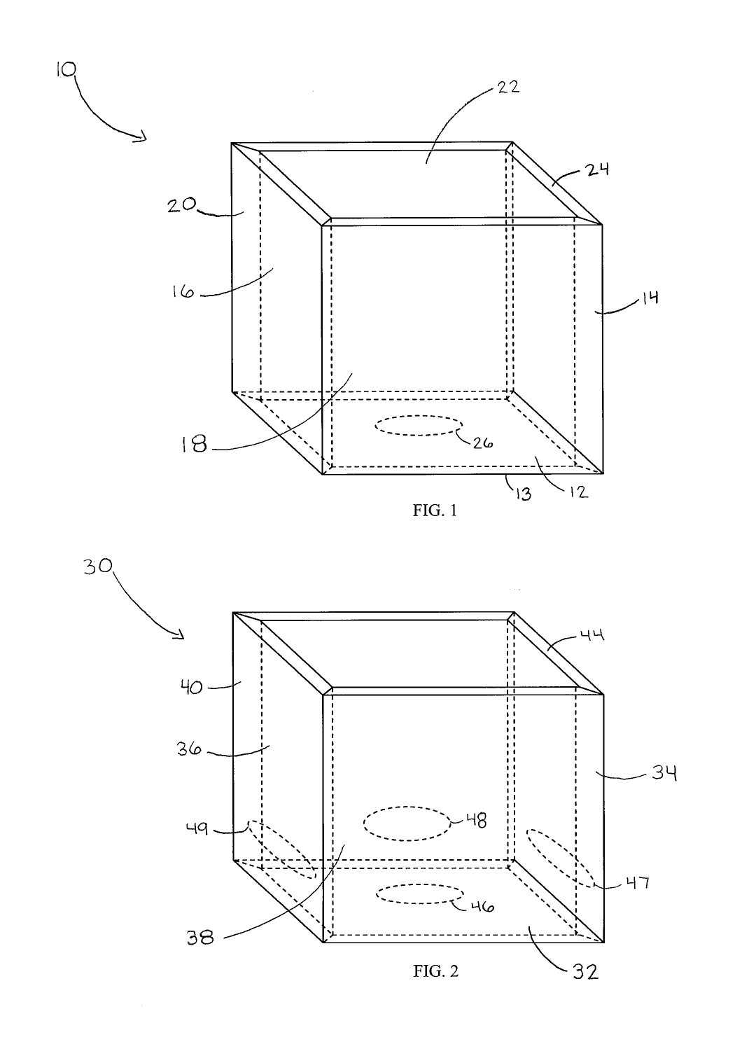

With more particularity and with reference to the drawings, FIG. 1 illustrates one embodiment of a biodegradable container, generally, denoted at 10. The container 10 includes a bottom wall 12 and an outside perimeter 13 of the bottom wall 12. At least one side wall 14 extends upward from the outside perimeter 13 of the bottom wall 12 to form the structure of the container 10. As shown, the container 10 further comprises side walls 16, 18, and 20.

As shown, walls 14, 16, 18, 20 cooperate to provide an opening 22 at the top of the container to enable potting soil, top soil or the like to be inserted into the container 10. The side walls 14, 16, 18, 20 comprise a nutrient material 24 for sustaining plant growth and one or more resins and/or gels (not shown) for bonding with the nutrients and maintaining a resilient structure. Furthermore, an aperture 26 is located in at least one side wall 14, 16, 18, or 20 or bottom wall 12. The aperture 20 is located on a sidewall, in order to provide an opening for roots to protrude outward and excess water to be released into the surrounding soil outside the container 10.

FIG. 2 illustrates another embodiment of the biodegradable container 30. According to this embodiment, the container 30 has a plurality of apertures 46, 47, 48, 49 located in side walls 34, 36, 38, 40 or bottom wall 32 of the container 30. The plurality of apertures 46, 47, 48, 49 are to be located equidistantly from one another. The plurality of apertures 46, 47, 48, 49 provide for the further spreading of the plant's roots and dispersing of excess water within the container 30. It is possible that all of the apertures be provided on only one of the walls 32, 34, 36, 38 or 40.

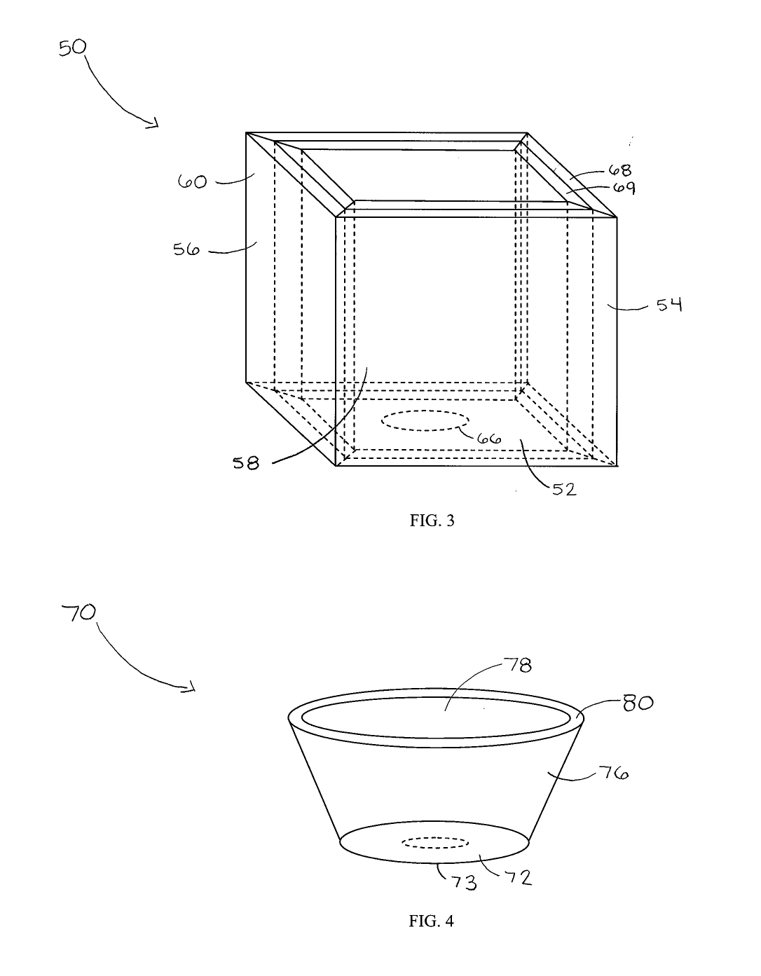

FIG. 3 illustrates a further embodiment of the biodegradable container 50. Here, the side walls 54, 56, 58, 60 and bottom wall 52 comprise alternating layers of both nutrient-present layers 68 and nutrient-absent layers 69. This embodiment incorporates the use of alternating layers of both nutrient-present layers 68 and nutrient-absent layers 69 in order to more fully control the amount of nutrients the plant receives while being watered after being planted in the ground.

FIG. 4 illustrates a further embodiment of the biodegradable container 70 comprising a single curvilinear side wall 76 extending upwardly and outwardly along the outside perimeter 73 of the bottom wall 72 to form a tapered structure of the container 70. The potting soil, including a plant or seed, is placed within the container 70 through the opening 78 provided at the top of the tapered side wall 76.

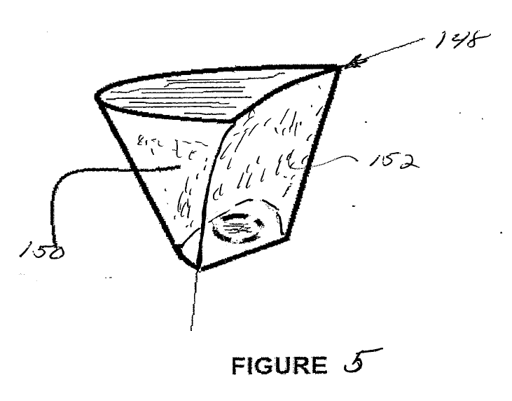

In FIG. 5, the container 100 assumes an irregular configuration defined by curvilinear side walls 102, 104 and 106.

The container hereof is manufactured by admixing the nutrient or fertilizer material together at room temperature along with any bonding resin or gel. The mixture is then compressed in a mold. After curing or setting the container is removed from the mold. Wherein the container is layered, the additional side wall is manufactured in a mold and is then placed into abutment with its coincident side wall, as shown in FIG. 3.

As shown in FIG. 5, after the container is manufactured it is then packed with potting soil 130 and optionally, with seeds or a plant, shown as seeds 152.

As the side wall may take the shape of any structure, a tapered structure is most preferable.

The present invention has advantages over the prior art in that it is environmentally friendly and biodegradable, and also in that it provides additional functionality for a growing container by acting as more than just a storage container and by otherwise allowing effective feeding of a plant with only the addition of water to the growing area. Specifically, the water-actuated growing container and unit of the present invention obviate the use of or need to discard any materials unsafe for the environment, reduces the amount of time that a user must spend in planting the seed or plant disposed therein, and substantially assists in the growth and sustenance of such seed or plant by gradually supplying it with additional nutrients contained within the growing container or unit themselves. By directly providing these extra nutrients to the seed or plant, the growing container and unit further reduce the time spent by an inconvenience imposed on the user in having to manually supply the seed or plant with such nutrients.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiments were chosen and described in order to best explain the principles of the present invention and its practical application, to thereby enable others skilled in the art to best utilize the disclosure and various embodiments with various modifications as are suited to the particular use contemplated.

Having thus described the invention, what is claimed is:

1. A water-actuated growing container for plants and/or seeds comprising:
a biodegradable container comprising at least one side wall and a bottom wall with a perimetral edge, wherein the at least one side wall extends upward from the edge of the bottom wall to define an open top container, and
at least one aperture provided within the container, the aperture allowing for excess water to be drained and any roots from the seeds or plants to protrude.

2. The water-actuated growing container of claim 1 wherein the at least one side wall and bottom wall of the container comprise nutrient material.

3. The water-actuated growing container of claim 2 further comprising one or more resins or gels for bonding together the nutrients, wherein the at least one side wall and bottom wall maintain a resilient structure.

4. The water-actuated growing container of claim 1 which further comprises a plurality of apertures placed equidistantly from each other along the at least one side wall and bottom wall of the container.

5. The water-actuated growing container of claim 1 wherein the at least one side wall has a tapered structure.

6. The water-actuated growing container of claim 1 wherein the container comprises alternating layers of nutrient-present layers and nutrient-absent layers within the at least one side wall and bottom wall.

7. The water-actuated growing container of claim 1 wherein the at least one side wall and bottom wall comprises a water dissolvable material.

8. The water-actuated container of claim 1 further comprising:
a potting soil disposed within the container; and
a plant or quantity of seeds planted in the soil.
